(19) United States
(12) Patent Application Publication
(10) Pub. No.: US 2025/0290828 A1
(43) Pub. Date: Sep. 18, 2025

(54) OPTICAL FIBER TESTING USING POLARIZATION OPTICAL TIME DOMAIN REFLECTOMETRY

(71) Applicant: EXFO INC., Quebec (CA)

(72) Inventor: Michel LECLERC, Quebec (CA)

(21) Appl. No.: 19/077,507

(22) Filed: Mar. 12, 2025

Related U.S. Application Data
(60) Provisional application No. 63/564,764, filed on Mar. 13, 2024.

(51) Int. Cl. G01M 11/00

(52) U.S. Cl. CPC G01M 11/3181; G01M 11/3145; G01M 11/3154

(57) ABSTRACT

A testing method for an optical fiber is provided. The method involves the use of a P-OTDR device to launch polarized light pulses from the P-OTDR device into the fiber extremity of an optical fiber and obtain a return light signal. Concurrently, a polarization state of light travelling in a distal fiber segment is varied, a polarization component of the return light signal is isolated, and a set of P-OTDR traces are acquired. The set of P-OTDR traces is processed to detect a change in polarization of the return light signal. Upon detecting such a change an information relative to the distal fiber segment and the fiber extremity can be reported. The method may for example be used as a fiber identification method or a geo-referencing method. A P-OTDR device is also provided.

### TECHNICAL FIELD

The technical field generally relates to optical fiber testing such as fiber identification of geo-referencing methods, and more particularly concerns a P-OTDR based fiber testing method and P-OTDR device.

### BACKGROUND

Optical fiber managements can be a challenge in a variety of contexts.

By way of example, fiber cabinets, even ones of modest size, can contain a large number of optical fibers which are typically jumbled together in such a way that visually or manually tracing the origin of any given fiber segment can be a challenging task.

Various tools are known in the art to allow fiber identification. Visual Fault Locators (VFLs), such as EXFO's FLS-240 pocket pal, are one of the most used tools for fiber identification. A VFL work by injecting visible light at one end of an optical fiber. Fiber segments to be tested are bent and an operator looks if VFL light can be seen leaking out of the bent through visual inspection. VFLs are however limited in range and can fail to provide the desired fiber identification in bend insensitive fibers, fibers with hard fiber jackets or other circumstances where a light leak cannot be visually observed.

Live Fiber Detectors (LFDs), such as EXFO's LFD-300B/TG-300B FiberFinder, are also known in the art to measure signals anywhere on singlemode optical fibers without having to disconnect them, based on non-destructive macrobending technology. LFDs can use light at wavelengths outside of the visible portion of the spectrum, for example in the infrared range, and can be used to extend the range typically available to VFLs with better sensitivity. Similarly to VFLs, however, LFDs depend on the ability to extract light from the fiber jacket. In particular, bend insensitive fibers are favored in current optical fiber systems as they offer greater mechanical flexibility, reliability, and compatibility in various applications where space is tight and in difficult environments such as in FTTH, inside buildings and in data centers.

It is also known in the art to used Optical Time Domain Reflectometry (OTDR) to detect a bend in an optical fiber. OTDR devices send laser pulse up through an optical fiber link and analyse the reflections returning to the device to detect signal losses and measure the distance of loss events from the optical fiber input. Referring for example to a technique developed by Kingfisher International (https://kingfisherfiber.com/application-notes/locating-cable-faults/), in the context of fiber identification, a portion of an optical fiber segment being tested is bent using a cold clamp. Liquid nitrogen is poured into the cold clamp, which creates a temporary optical loss point. This approach can be complicated to implement from the need to manipulate liquid nitrogen and may not scale well when applied to a large number of optical fiber segments for testing. Other OTDR solutions may be based on the use of pliers or pinching implements to bend the fiber but are of limited effectiveness for bend insensitive fibers, which are designed to have very low loss when bent. Obtaining a clear, measurable loss can also require imposing a lot of mechanical stress on the fiber jacket, which may make approaches based a fiber bending difficult to implement for fibers with large fiber jackets.

There remains a need in the art for an approach to fiber identification that alleviates at least some of the drawbacks of the prior art.

### SUMMARY

In accordance with one aspect, there is provided a testing method for an optical fiber system comprising a fiber extremity and a distal fiber segment, the method comprising:
a) using a P-OTDR device connected to the fiber extremity, continuously launching polarized light pulses from the P-OTDR device into the fiber extremity and obtaining a return light signal from said fiber extremity;
b) concurrently to the launching of the polarization light pulses:
   i. acting on the distal fiber segment to vary a polarization state of light travelling therein; and
   ii. isolating a polarization component of the return light signal, and acquiring a set of P-OTDR traces therefrom;
c) processing the set of P-OTDR traces to detect a change in polarization of the return light signal; and
d) upon detecting said change in polarization of the return light signal, reporting an information relative to the distal fiber segment and the fiber extremity.

In some implementations, acting on the distal fiber segment comprises:
shaping a portion of the distal fiber segment into a curved portion having a curvature larger than a minimum bend radius of the distal fiber segment, the curved portion extending substantially within a plane containing a fiber axis of the distal fiber segment; and
pivoting the curved portion of the distal fiber segment about said fiber axis.

In some implementations, the pivoting of the curved portion of the distal fiber segment extends over a maximum range of about 180 degrees.

In some implementations, the pivoting of the curved portion of the distal fiber segment is performed back and forth.

In some implementations, the testing method comprises providing an automated fiber-moving device, the automated fiber-moving device comprising:
a curved fiber-receiving container, the shaping of a portion of the distal fiber segment into a curved portion comprising inserting the portion of the distal fiber segment into the curved fiber-receiving container; and
a motorized mechanism configured to pivot the curved fiber-receiving cavity about a pivot axis, thereby pivoting the curved portion of the distal fiber segment.

In some implementations, processing the set of P-OTDR traces comprises:
selecting a block of N consecutive ones of said P-OTDR traces, each P-OTDR trace comprising intensity values of the polarization component of the return light signal as a function of distance indices;
for each distance index, computing a variation indicator based on the intensity values associated with said distance index in the P-OTDR traces within said block;
building a detection trace representative of said variation indicator as a function of distance indices;
identifying a transition in the detection trace at a transition distance index for which the variation indicator is above a transition threshold.

In some implementations, the computing of a variation indicator comprises at least one of:
computing a difference between a maximum and a minimum of the intensity values associated with said distance index;
computing a standard deviation of the intensity values associated with said distance index;
computing a Fourier transform of the intensity values associated with said distance index; and
computing a median absolute deviation of the intensity values associated with said distance index.

In some implementations, said information comprises an indication that the distal fiber segment and the fiber extremity belong to a same optical fiber.

In some implementations, said information comprises a light-propagation distance between the fiber extremity and the distal fiber segment along a corresponding optical fiber.

In accordance with another aspect, there is provided a fiber-identification method for an optical system having a plurality of optical fibers each having a fiber extremity and a distal fiber segment, the method comprising the steps of:
a) using a P-OTDR device connected to the fiber extremity of one of said optical fibers defining a test optical fiber, continuously launching polarized light pulses from the P-OTDR device into the fiber extremity of the test optical fiber and obtaining a return light signal from said test optical fiber;
b) isolating a polarization component of the return light signal, and acquiring a set of P-OTDR traces therefrom;
c) concurrently to the launching of the polarization light pulses:
   i. acting on a selected one of the distal fiber segments to vary a polarization state of light travelling therein; and
   ii. processing the set of P-OTDR traces to detect a change in polarization of the return light signal; and
d) if a change in polarization of the return signal is not detected, repeating step d) using a different one of said distal fiber segments as the selected distal fiber segment; and
e) upon detecting a change in polarization of the return light signal, reporting an association of the corresponding distal fiber segment with the test optical fiber.

In some implementations, acting on a selected one of the distal fiber segments comprises:
shaping a portion of the selected distal fiber segment into a curved portion having a curvature larger than a minimum bend radius of the selected distal fiber segment, the curved portion extending substantially within a plane containing a fiber axis of the selected distal fiber segment; and
pivoting the curved portion of the selected distal fiber segment about said fiber axis.

In accordance with another aspect, there is provided a geo-referencing method for an optical fiber having an accessible fiber extremity and a distal fiber segment, the method comprising:
a) using a P-OTDR device connected to the fiber extremity, continuously launching polarized light pulses from the P-OTDR device into the fiber extremity and obtaining a return light signal from said optical fiber;
b) isolating a polarization component of the return light signal, and acquiring a set of P-OTDR traces therefrom;
c) concurrently to the launching of the polarization light pulses:
   i. acting on the distal fiber segment to vary a polarization state of light travelling therein; and
   ii. processing the set of P-OTDR traces to detect a location of a change in polarization of the return light signal;
d) calculating a light-propagation distance between the fiber extremity and the location of a change in polarization of the return light signal; and
e) associating a geographical location of the distal fiber segment with said light-propagation distance.

In some implementations, acting on the distal fiber segment comprises:
shaping a portion of the distal fiber segment into a curved portion having a curvature larger than a minimum bend radius of the distal fiber segment, the curved portion extending substantially within a plane containing a fiber axis of the distal fiber segment; and
pivoting the curved portion of the distal fiber segment about said fiber axis.

In accordance with yet another aspect, there is provided a P-OTDR device for testing an optical fiber system comprising a fiber extremity and a distal fiber segment, a polarization state of light travelling in the distal fiber segment being varied, the P-OTDR device comprising:
a polarized light source for generating polarized light pulses;
a connector connectable to the fiber extremity for launching the polarized light pulses from the polarized light source into the fiber extremity and receive a return light signal therefrom;
a polarizing module for isolating a polarization component of the return light signal;
an acquisition optical circuit for acquiring a set of P-OTDR traces from the polarization component of the return light signal; and
an OTDR acquisition controller operable to synchronously launch the polarized light pulses from the polarized light source into the optical fiber extremity and acquire the set of P-OTDR traces;
a signal processor for processing the OTDR trace to detect a change in polarization of the return light signal and, upon detecting said change in polarization of the return light signal, report an information relative to the distal fiber segment and the fiber extremity.

In some implementations, the polarizing module comprises a polarizer.

In some implementations, the polarizing module is positioned in a path of the return signal between the connector and the acquisition optical circuit.

In some implementations, the polarizing module is disposed downstream the connector along an optical fiber associated with the fiber extremity.

In some implementations, the P-OTDR device is configured to operate in a P-OTDR mode and in a standard OTDR mode.

In accordance with another aspect, there is provide a P-OTDR device as above, in combination with an automated fiber-moving device for acting on the distal fiber segment to vary the polarization state of light travelling therein. In some implementations, the automated fiber-moving device comprises:
a curved fiber-receiving cavity, the curved portion of the distal fiber segment being inserted therein; and
a motorized mechanism configured to pivot the curved fiber-receiving cavity about a pivot axis, thereby pivoting the curved portion of the distal fiber segment.

Other features and advantages will be better understood upon of reading of detailed embodiments with reference to the appended drawings.

### BRIEF DESCRIPTION OF THE DRAWINGS

FIG. 1 schematically illustrates a testing method for an optical fiber system according to one embodiment.

FIG. 2 schematically illustrates a P-OTDR device according to one embodiment.

FIG. 3 illustrates the processing of a set of P-OTDR traces acquired through a testing method according to one embodiment.

FIGS. 4A and 4B respectively shown two P-OTDR traces and the resulting Minimum-Maximum P-OTDR detection trace.

FIGS. 5A to 5C show an information corresponding a current state of the P-OTDR device transmitted by the P-OTDR device, for instances where the P-OTDR device is not started (FIG. 5A), the P-OTDR device is detecting movement but not continuous (FIG. 5B) and, the P-OTDR device is detecting a continuous movement (FIG. 5C).

FIG. 6A illustrates the shaping of a portion of a distal fiber segment into a curved portion; FIG. 6B illustrates the pivoting of the curved portion of the distal fiber segment.

FIGS. 7A and 7B are respectively a side elevation view and a schematic representation of an automated fiber-moving device; FIG. 7C shows a wireless communication device in communication with the automated fiber-moving device.

FIGS. 8A and 8B are schematic representations of configurations of the P-OTDR devices.

FIGS. 9 and 10A to 10C illustrated different examples of configurations of a polarizing module.

FIGS. 11 and 12 schematically illustrate fiber-identification methods for an optical fiber system according to one embodiment.

FIGS. 13A to 13C illustrate a fiber-identification method applied to PON (FIG. 13A) or ONU (FIGS. 13B and 13C) identification.

FIG. 14 schematically illustrates a geo-referencing method for an optical fiber system according to one embodiment.

FIG. 15 schematically illustrates a use case for a geo-referencing method for an optical fiber system according to one embodiment, applied to fault detection.

FIG. 16 schematically illustrates a use case for a fiber testing method for an optical fiber system according to one embodiment, applied to monitor the activity at a specific location on an optical network.

### DETAILED DESCRIPTION

Various representative implementations of the described technology will be described more fully hereinafter with reference to the accompanying drawings, in which representative implementations are shown. The present technology concept may, however, be implemented in many different forms and should not be construed as limited to the representative implementations set forth herein. Rather, these representative implementations are provided so that the disclosure will be thorough and complete, and will fully convey the scope of the present technology to those skilled in the art. In the drawings, the sizes and relative sizes of layers and regions may be exaggerated for clarity. Like numerals refer to like elements throughout.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

It will be understood that, although the terms first, second, third, etc. may be used herein to describe various elements, these elements should not be limited by these terms. These terms are used to distinguish one element from another, without necessarily imparting a preferred order or sequence to these elements. Thus, a first element discussed below could be termed a second element without departing from the teachings of the present technology. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagram herein represents conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “controller”, “processor” or “processing unit”, may be provided through the use of dedicated hardware as well as hardware capable of executing software in association with appropriate software and according to the methods described herein. When provided by a processor, the functions may be provided by a single dedicated processor, by a single shared processor, or by a plurality of individual processors, some of which may be shared. In some implementations of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules or units which are implied to be software, may be represented herein as any combination of flowchart elements or other elements indicating performance of process steps and/or textual description. Such modules may be executed by hardware that is expressly or implicitly shown, the hardware being adapted to (made to, designed to, or configured to) execute the modules. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present disclosure.

The present description generally concerns embodiments of a testing method for an optical fiber system comprising a fiber extremity and a distal fiber segment. P-OTDR devices for testing an optical fiber system are also provided. In accordance with different use cases, as explained in more details below, the testing method may be a fiber-identification method, a geo-referencing method or other type of testing method involving one of more fiber extremities and one or more distal fiber segments that need to be related to each other in some fashion.

In accordance with one aspect, the fiber-testing method generally involve the following steps:
a) using a P-OTDR device connected to the fiber extremity, continuously launching polarized light pulses from the P-OTDR device into the fiber extremity and obtaining a return light signal from said fiber extremity;
b) concurrently to the launching of the polarization light pulses:
   i. acting on the distal fiber segment to vary a polarization state of light travelling therein; and
   ii. isolating a polarization component of the return light signal, and acquiring a set of P-OTDR traces therefrom;
c) processing the set of P-OTDR traces to detect a change in polarization of the return light signal; and
d) upon detecting said change in polarization of the return light signal, reporting an information relative to the distal fiber segment and the fiber extremity.

As will be readily understood by one skilled in the art, the testing method makes use of Polarization Optical Time Domain reflectometry (P-OTDR) to test an optical fiber system and provide an information relative to a distal fiber segment and a fiber extremity within this optical fiber system.

Optical Time-Domain Reflectometry (OTDR—also used to refer to the corresponding device) is widely employed for characterization of optical fiber links. OTDR is a diagnostic technique where a test light signal in the form of light pulses is launched in the optical fiber link under test and the return light signal, arising from backscattering and reflections along the link, is detected and analyzed. The acquired power level of the return light signal as a function of time is referred to as an “OTDR trace” or a “reflectometric trace”, where the time scale is representative of distance between the OTDR acquisition device and a point along the fiber link. Herein, the process of launching a test light signal and acquiring the return light signal to obtain therefrom an OTDR trace may be referred to as an “OTDR acquisition”.

In the following description, techniques that are generally known to the ones skilled in the art of OTDR measurement and OTDR trace processing and analysis will not be explained or detailed and in this respect, the reader is referred to available literature in the art. Such techniques that are considered to be known may include, e.g., signal processing methods for identifying and characterizing events from an OTDR trace. Similarly, an OTDR acquisition device is understood to comprise conventional optical hardware and electronics as known in the art for performing OTDR acquisitions on an optical fiber link.

Each OTDR acquisition is understood to refer to the actions of propagating a test light signal comprising one or more test light pulses having the same pulse width in the optical fiber link, and detecting a corresponding return light signal from the optical fiber link as a function of time. A test light signal travelling along the optical fiber link will return towards its point of origin either through (distributed) backscattering or (localized) reflections. As mentioned above, the acquired power level of the return light signal as a function of time is referred to as the OTDR trace, where the time scale is representative of distance between the OTDR acquisition device and a point along the optical fiber link. Light acquisitions may be repeated with varied pulse width values to produce a separate OTDR trace for each test pulse width.

One skilled in the art will readily understand that in the context of OTDR methods and systems, each light acquisition generally involves propagating a large number of substantially identical light pulses in the optical fiber link and averaging the results. In this case, the result obtained from averaging may be referred to herein as the OTDR trace. It will also be understood that other factors may be controlled during the light acquisitions or from one light acquisition to the next, such as gain settings, pulse power, etc. as is well known to those skilled in the art.

In the context of the present description, the expression “backscattering” is understood to refer to Rayleigh scattering occurring from the interaction of the travelling light of the test light signal with the optical fiber media all along the fiber link, resulting in a generally sloped background light (in logarithmic units, i.e. dB, on the ordinate) on the OTDR trace, whose intensity disappears at the end of the range of the travelling pulse. “Events” along the fiber will generally result in a more localized drop of the backscattered light on the OTDR trace, which is attributable to a localized loss, and/or in a localized reflection peak. It will be understood that an “event” characterized by the OTDR method described herein may be generated by any perturbation along the fiber link which affects the returning light. Typically, an event may be generated by an optical fiber splice along the fiber link, which is characterized by a localized loss with little or no reflection. Mating connectors can also generate events that typically present reflectance, although these may be impossible to detect in some instances. OTDR methods and systems may also provide for the identification of events such as a fiber breakage, characterized by substantial localized loss and, frequently, a concomitant reflection peak, as well as loss resulting from a bend in the fiber. Finally, any other component along the fiber link may also be manifest as an “event” generating localized loss.

OTDR technology can be implemented in different manners and advanced OTDR technology typically involves multi-pulse acquisitions and analysis whereby the OTDR acquisition device makes use of multiple acquisitions performed with different pulse widths in order to provide different spatial resolutions and noise level conditions for event detection and measurement along the optical fiber link under test and provide a complete mapping of the optical fiber link. As such, an OTDR measurement may comprise multiple OTDR acquisitions performed with different pulse widths or other varying conditions. One or more OTDR traces acquired for a given OTDR measurement may be saved as part of an OTDR measurement data file or files.

P-OTDR is a technique that uses the State Of Polarization (SOP) of the backscattered light in OTDR acquisitions to measure the characteristics of optical fibers, such as polarization mode dispersion (PMD), birefringence, and stress. Some of the applications of P-OTDR include distributed sensing of intrusion (Linze et al., “Development of an Intrusion Sensor Based on a Polarization-OTDR System”, IEEE Sensors Journal, Volume 12, Issue 10, October 2012) and characterization of telecommunication fibers, for example PMD measurements (see spec sheet for EXFO's FTB-5600 https://www.exfo.com/umbraco/surface/file/download/?ni=32401 &cn=en-US).

Polarization considerations in optical fiber links have been studied since the early 2000s, when Polarization Mode Dispersion (PMD) has been identified as a problem on long fiber links. These studies include measurement of the evolution of the SOP through time. The conclusions of these studies are that the SOP rate of change is very low in buried fiber, and faster in aerial fiber while still relatively low. For example, Sheryl L. Woodward et al. (Long-Term Observation of PMD and SOP on Installed Fiber Routes, IEEE PHOTONICS TECHNOLOGY LETTERS, VOL. 26, NO. 3, Feb. 1, 2014) reported having performed an extensive long-term study of the polarization behavior of buried fibers by using coherent transponders deployed in terrestrial routes. Over an 18-month period, over 10,000 hours of monitoring data on the SOP and PMD was collected and it was determined that changes in SOP and PMD were on the order of days. David S. Waddy, Liang Chen, Xiaoyi Bao (“Polarization effects in aerial fibers” Optical Fiber Technology 11 (2005) 1-19) measured the effect of the Stokes parameter that shows fluctuations of 1.3 Hz and less. A clear band was observed at 0.51 Hz. The band is more pronounced with sustained winds.

Embodiments of the fiber testing method described herein uses polarization properties of light interacting with the topology of the optical fiber cable. The effect used is sometimes referred to as the topological phase or Berry's phase (see https://en.wikipedia.org/wiki/Geometric_phase#Polarized_light_in_an_optical_fiber and M. V. Berry, “Quantal Phase Factors Accompanying Adiabatic Changes”, Proceedings of the Royal Society of London, Series A, Mathematical and Physical Sciences, Vol. 392, No. 1802, Mar. 8, 1984, pp. 45-57). Berry's phase is a geometric phenomenon that occurs when the direction of propagation of light is changed, while the optical path length remains unchanged. It can be observed in optical fibers, especially in coiled or helically wound ones. When moving an optical fiber segment in space from one plane to another, the corresponding change in the topological path modifies the polarization state of the light travelling in the optical fiber, which can be observed by a remote instrument. Since, as mentioned above, polarization movements on installed network are generally low, then the suggested induced polarization movement approach, preferably at an excitation frequency higher than those inherent to the network, can yield a detectable signal.

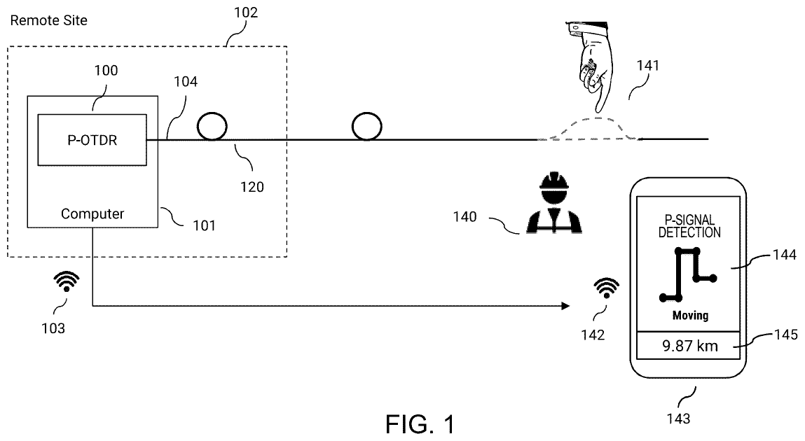

Referring to FIG. 1, there is shown an example of implementation of the testing method described herein.

A P-OTDR 101 device is connected to an optical fiber 120 to find or identify, at a remote site 102 where access to one fiber extremity 104 of the optical fiber 120 is granted. The P-OTDR device 101 may for example include a computer and a P-OTDR acquisition card 100 configured to control the acquisition sequence and output the results. In some variants, the P-OTDR device may be wirelessly paired with an associated portable device 143 such as a smartphone or the like, carried by an operator 140.

The operator 140 is on the site where a specific distal fiber segment 141 needs to be found or identified. The operator remotely starts the P-OTDR device using controls provided on the portable device 143. When the P-OTDR device is active, as for example reported or displayed on the portable device 143, the operator 140 applies a movement to the distal fiber segment 141 to create a detectable change in polarization in light travelling in the optical fiber 120. When the P-OTDR device 101 detects this polarization change, it transmits a detection indication and the position 144 of the distal fiber segment 141 to which the movement has been applied. In the illustrated example, a P-OTDR detection status signal 103 is sent via the wireless capability of the P-OTDR device 101 and received as a detection status signal 142 by the associated portable device 143, also wirelessly. Once the detection status signal 143 is received, a detection status indicator 144 and/or a distance indicator 145 of the detect polarization change is displayed on the portable device 143.

The P-OTDR device 101 may be embodied by any device configured to perform the related function. Typically, the P-OTDR device operates in the same manner as a traditional OTDR, with the difference that it makes use of polarized light, and includes a polarizer or similar device ahead of the light detector, as explained further below.

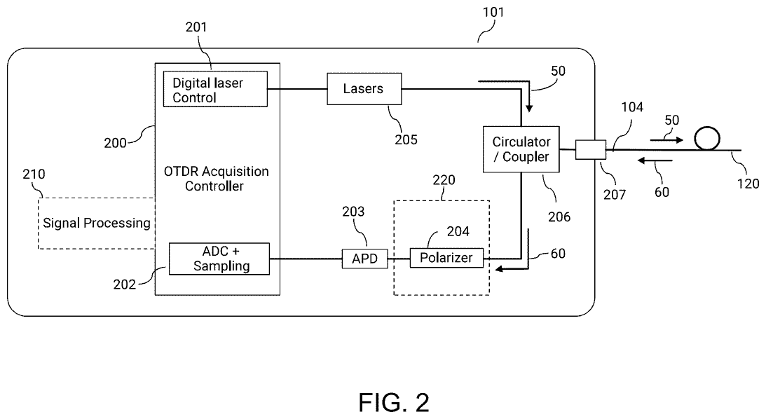

Referring to FIG. 2, there is shown an example of a P-OTDR device 101 according to one embodiment. The illustrated P-OTDR device is configured for testing an optical fiber system comprising a fiber extremity and a distal fiber segment, wherein the polarization state of light travelling in the distal fiber segment is varied, for example as shown in FIG. 1 described above.

The P-OTDR device 101 first includes a polarized light source 205 for generating polarized light pulses 50. The polarized light source 205 may include one or more lasers which emits OTDR pulses at specific wavelengths. In some variants the laser or lasers is configured to emit light pulses that are polarized. In other variants the polarized light source 205 may include one of more lasers generating unpolarized light pulses coupled with a polarizer imposing the desired SOP on the light pulses from the laser.

The P-OTDR device 101 further includes a connector 207 connectable to the fiber extremity 104 of a fiber under test 120 for launching the polarized light pulses 50 from the polarized light source 205 into the fiber extremity 104 and receive a return light signal 60 therefrom. The connector 207 may have any structure known in the art. One or more optical components may be provided to direct or change properties of the polarized light pulses 50 and/or the return light signal 60. For example, in the illustrated embodiment the P-OTDR device 101 includes a circulator or a coupler 206 configured to inject the polarized light pulses 50 into and receive the backscattered return light signal 60 from the fiber under test 120.

The P-OTDR device 101 further includes a polarizing module 220 for isolating a polarization component of the return light signal 60. In the illustrated embodiment, the polarizing module 220 includes a polarizer 204 provided in an optical path of the return light signal 60 prior to detection. An acquisition optical circuit for acquiring a set of P-OTDR traces from the polarization component of the return light signal is further provided. Il the illustrated embodiment, the acquisition optical circuit includes an Avalanche Photo Diode (APD) 203 provided after the polarizer 204 and converting light of the isolated polarization component exiting the polarizer 204 into an equivalent current signal. In alternative embodiments, a PIN photodiode could be used. An OTDR acquisition controller 200 is further provided to synchronously launch the polarized light pulses 50 from the polarized light source 205 into the optical fiber extremity 104 and acquire the set of P-OTDR traces. The OTDR Acquisition controller may include a digital laser control 201 which sends control signals to the laser 205 to emits the OTDR pulses 50, and an Analog Digital Converter (ADC) and a sampling control 202 to acquire the OTDR traces from the current signal of the ADP 203. In some implementations, the ADC and sampling control 202 are configured to acquire P-OTDR traces at a sampling rate allowing the movement detection. By way of example, a suitable sampling rate for manual and simple movement detection may be about 5 Hz such that each trace lasts about 200 ms.

The P-OTDR device 101 finally includes a signal processor 210 for processing the OTDR traces to detect a change in polarization of the return light signal 60 and, upon detecting the change in polarization of the return light signal 60, report an information relative to the distal fiber segment and the fiber extremity.

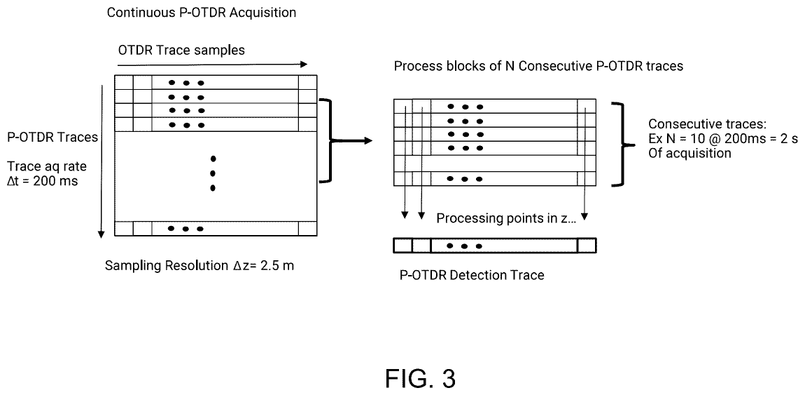

FIG. 3 illustrates the processing of the set of P-OTDR traces acquired through the present testing method according to one embodiment. A block of N consecutive P-OTDR traces is selected. The choice the number N of P-OTDR traces is preferably large enough to cover the duration of the movement of the distal fiber segment, but short enough to have a suitably fast response time. As understood by those skilled in the art, each P-OTDR trace corresponds to a variation of the intensity value of the polarization component of the return light signal as a function of distance indices (correlated to time of travel in the optical fiber). For each distance index, a variation indicator based on the intensity values associated with this distance index in the P-OTDR traces within the block of N P-OTDR traces is computed. A vector of length N providing the SOP variation indicators seen by the polarizer is therefore obtained for each distance index. A detection trace representative of these variation indicators as a function of distance indices is then built from this vector. There are different ways to perform this operation, for example based on:
The difference between the maximum and the minimum of the points of the vector (in dB OTDR, or through a linear approach through an amplitude normalisation process)
The standard deviation of the points of the vector (in dB OTDR)
If enough points are available a Fourier transform may be used on the P-OTDR traces, for example if the distal fiber segment is moved at a specific frequency.
A median absolute deviation algorithm, similarly to the standard deviation.

Averaging could be applied on the P-OTDR traces as well.

Each of the methods above has its strength. For example, the difference between the maximum and minimum of the points allows to immediately detect a change in polarization, while the standard deviation approach or the absolute median approach can detect a continuous movement. The Fourier transform method allows to link the data with the movement speed of the optical fiber segment.

Detecting a transition in the detection trace at a transition distance index for which the variation in the intensity values is above a transition threshold can provide the desired information relative to the distal fiber segment and the fiber extremity.

In the example of FIG. 3, a movement of the distal fiber segment at a rate of about 1 second and a sampling rate of about 200 ms are considered. The selected number of consecutive OTDR traces N=10 which corresponds to a detection time of about 2 seconds.

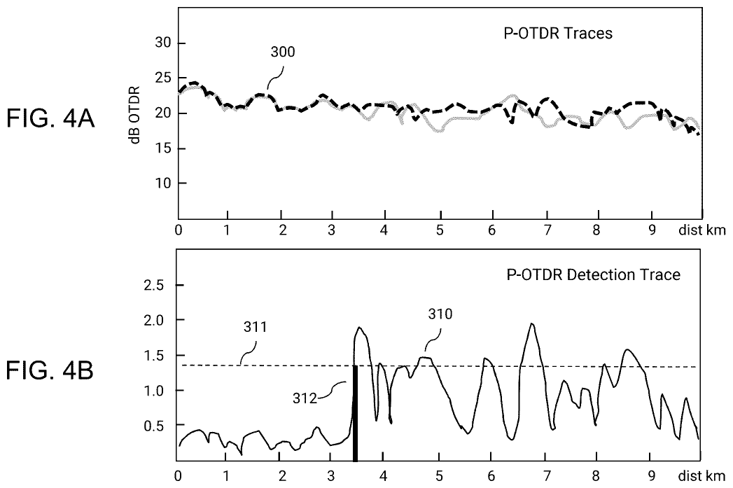

FIGS. 4A and 4B provide an example of two P-OTDR traces 300, and the resulting Minimum-Maximum P-OTDR detection trace 310. To detect the movement, a threshold 311 may be used on the detection trace. In this variant, the position where the detection trace goes beyond the threshold 312 is the detected position of the movement.

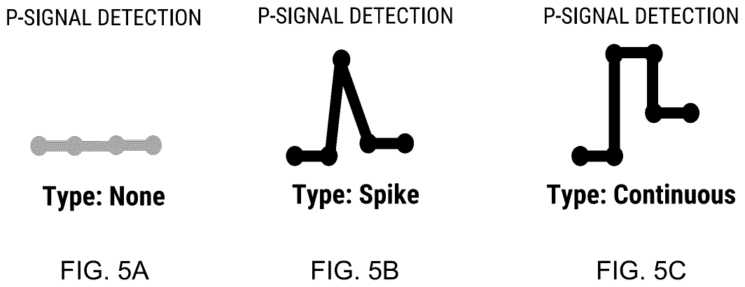

In some variants, the running of the testing method may be followed by the operator 140 on the remote device 143, as illustrated in FIG. 1. An information corresponding to the current state of the P-OTDR device may be transmitted by the P-OTDR device 101 to the remote device 143. Examples of such states are illustrated FIGS. 5A to 5C. In the example of FIG. 5A, the P-OTDR device is not started, or the P-OTDR device is running but no movement is detected. In the example of FIG. 5B, the P-OTDR device is detecting movement but not continuous and shows as a fast spike. This information may be useful for a first fast verification. In the example of FIG. 5C, the P-OTDR device is detecting a continuous movement, which can for example correspond to the distal fiber segment being moved by an automated fiber-moving device such as explained below.

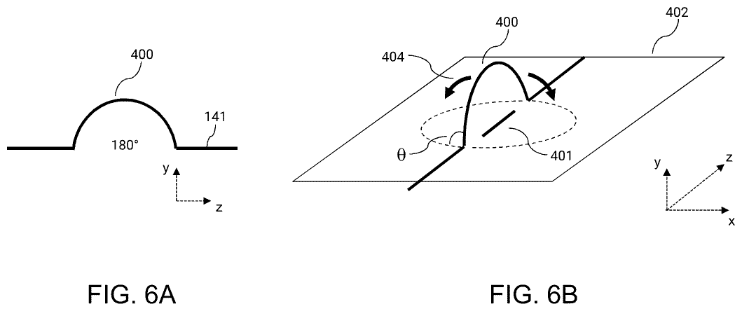

In some implementations, the polarization state of light travelling in the distal fiber segment is varied by moving the distal fiber segment. Referring to FIG. 6A, this may for example be accomplished by shaping a portion of the distal fiber segment 141 into a curved portion 400 extending substantially within a plane containing a fiber axis z of the distal fiber segment 141. It will be readily understood the cartesian reference system is used herein only to facilitate reference to the figures. The fiber axis z may roughly correspond to the orientation of the portions of the distal fiber segment 141 immediately preceding and following the curved portion 400. As shown in FIG. 6A, the curved portion 400 may form an arc of about 180 degrees, or about half a circle. The bending radius defined by the curved portion 400 does not have a significant impact on the variation of the SOP. Preferably, the curved portion 400 has a curvature larger than the minimum bend radius of the distal fiber segment 141, such that losses of light associated with a bend in the fiber are avoided. Referring to FIG. 6B, the curved portion 400 of the distal fiber segment 141 is then pivoted 404 about this fiber axis z, which therefore defines a pivot axis 401. In some implementations, the pivoting of the curved portion 404 is performed back and forth over a maximum range of about 180 degrees. In other words, the plane of the curved portion 400 has an angle θ with respect to a reference place 402 which varied between 0 degrees and 180 degrees. As will be readily understood by one skilled in the art, the pivoting action 404 will modify the polarization state of light travelling in the distal fiber segment 141 and returned to the P-OTDR device. In some embodiments the speed of this movement is selected to be in line with the acquisition period. The time taken for the angle θ to make one pass between 0 degrees to 180 degrees may roughly correspond to the acquisition period, for example about 1 second.

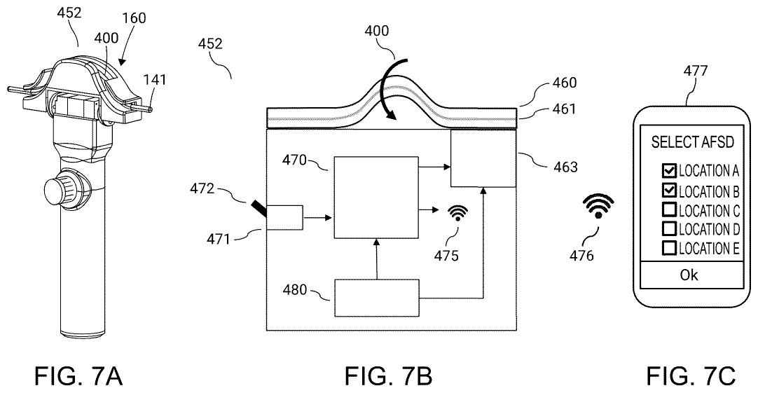

In some implementations, the pivoting of the curved portion 400 of the distal fiber segment 141 may be applied by hand by an operator, which can be efficient and simple in some implementations. Referring to FIGS. 7A to 7C, in other variants, an automated fiber-moving device 452 may be provided and employed. Advantageously, using au automated fiber-moving device may ensure the reliability of the procedure and of the synchronization of the movement with the acquisition process.

In typical implementations, the automated fiber-moving device 452 moves the curved portion of the distal fiber segment continuously thus, changing the polarization of light travelling in the distal fiber segment at a specific movement speed. The movement speed induced by the device may be pre-defined and provided to the signal processor 210. The standard deviation or the median absolute deviation methods may allow to detect a continuous movement of the SOP change. The Fourier Transform method may also be used to determine whether there is a continuous movement of the SOP change, which continuous movement would appear as a frequency peak, and optionally it can further retrieve the speed of the detected SOP change and confirm whether or not it corresponds to the movement frequency as induced by the automated fiber-moving device 452. The continuous movement and/or the pre-defined movement speed can both advantageously reduce the risk of false detection and improve the robustness of the method.

Referring more particularly to FIGS. 7A and 7B, in some variants, the automated fiber-moving device 452 may include a curved fiber-receiving container 460. The shaping of the distal fiber segment 141 into the curved portion 400 therefore entails inserting the portion of the distal fiber segment 141 into the curved fiber-receiving container 460, for example along a channel 461 having the desired curved shape.

As best seen in FIG. 7B, the automated fiber-moving device 452 may further include a motorized mechanism configured to pivot the curved fiber-receiving container 460 about a pivot axis, thereby pivoting the curved portion 400 of the distal fiber segment 141. In the illustrated example the motorized mechanism includes a motor 463 configured to move 404 the curved fiber-receiving container 460, and a control unit 470 which turn on and off the motor movement. The control unit may receive a control signal from a switch 471 which can be activated by a mechanical actuator 472, or from a wireless communication device 477 (see FIG. 7C). In some variants, the control unit 470 may provide different speed of movement. A battery 480 supplies power to the automated fiber-moving device 452. In some embodiments, the automated fiber-moving device 452 may be an IoT device controllable remotely. In such variants the automated fiber-moving device may includes a wireless communicator 475 allowing motor control (On/Off/Speed) and broadcasting of its state. A wireless communication signal 476 received from the remote-control unit 477, such as for example a smartphone, may turn on and off the automated fiber-moving device 452, and consult its state.

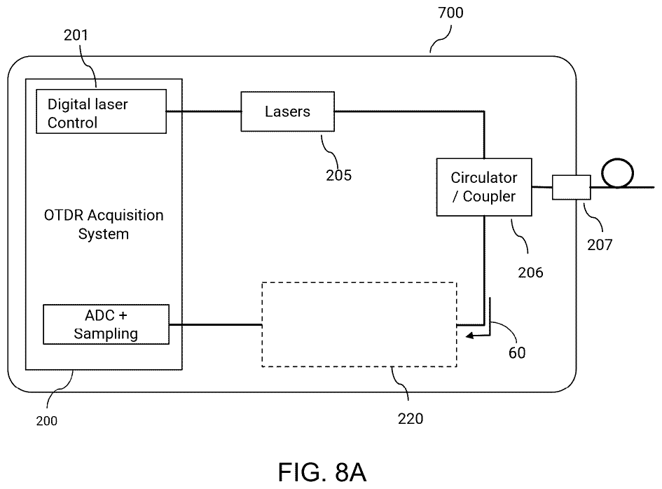

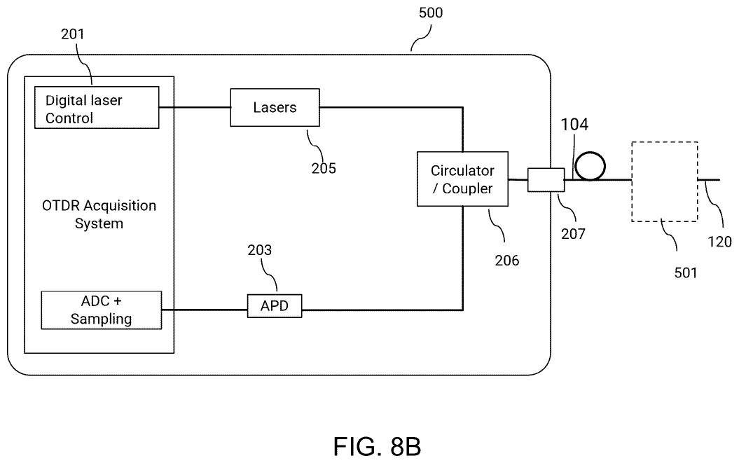

Referring to FIGS. 8A to 10C, various configurations of the P-OTDR device are presented by way of example.

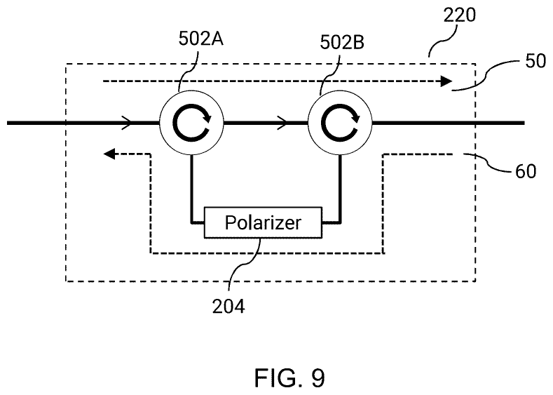

Referring more specifically to FIG. 8A, in some configurations, the polarizing module 220 may be provided inside a generic or standard OTDR device, and may be positioned in a path of the return signal 60 between the connector 206 and the OTDR acquisition controller 200. One simple embodiment of such a configuration is the provision of a polarizer 204 inside the OTDR, in front of the ADP 203, as illustrated in FIG. 2. Referring to FIG. 8B, in other configurations, the polarization module 220 may be provided outside of a generic or standard OTDR 500 and may be disposed downstream the connector 207 along an optical fiber 120 associated with the fiber extremity 104. Referring to FIG. 9, there is shown an example of a polarization module 220 for a such a configuration. In this variant, the polarizing module 220 includes a pair of circulators 502A and 502B which direct the polarized light pulses 50 to the fiber under test 120 and redirect the return light signal 60 from the fiber under test 120 through the polarizer 504 and then back to the OTDR.

In some implementations, internal configurations may have the advantage of offering an integrated solution designed and optimized for this purpose, while external configurations may have the advantage of reusing of the shelve existing OTDR.

Furthermore, in some embodiments the P-OTDR device may have a hybrid configuration combining capabilities of both P-OTDR and traditional OTDR.

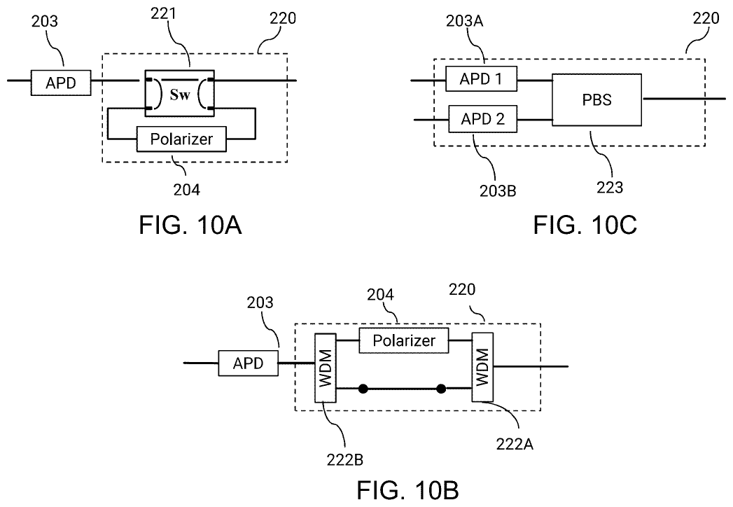

FIGS. 10A to 10C illustrated different examples of configurations of the polarizing module 220. In the embodiment of FIG. 10A, a polarizer 204 is provided in parallel to the optical path of the return signal through a switch 221 which allows to select between P-OTDR or standard OTDR operation. This configuration therefore advantageously combines standard OTDR and P-OTDR capabilities using a same device. In the embodiment of FIG. 10B, the polarizer 204 inside the OTDR device is integrated within a passive wavelength selective optical circuit composed of two optical paths using two WDM (Wavelength Division Multiplexing) filters 222A and 222B. The P-OTDR function is therefore active for specific wavelengths selected by the selective optical circuit. This configuration also combines standard OTDR and P-OTDR capability, but for specific wavelengths only. It will be noted that the polarizing module configurations shown in FIGS. 10A and 10B may be used either inside or outside of the OTDR. The embodiment of FIG. 10C makes use of a PBS (Polarization Beam Splitter) 223. In this configuration, the polarizer of the previous variants is replaced by a PBS 223 and two APDs 203A and 203B. This configuration allows to operate both OTDR and P-OTDR modes at the same time by sampling in parallel both APDs 203A and 203B. Once calibrated, summing the traces from both APD 203A and APD 203b provide a regular OTDR trace, since the total power of the PBS output provides the total power. Analyzing independently the signals from APD 203A or APD 203B provides the P-OTDR function.

As will be readily understood by one skilled in the art, the fiber testing method and device described above may be of use in a variety of contexts. Several examples of use cases are presented below. It will however be readily understood that these examples are non-limitative and that other use cases could be envisioned without departing from the scope of protection.

### Use Cases

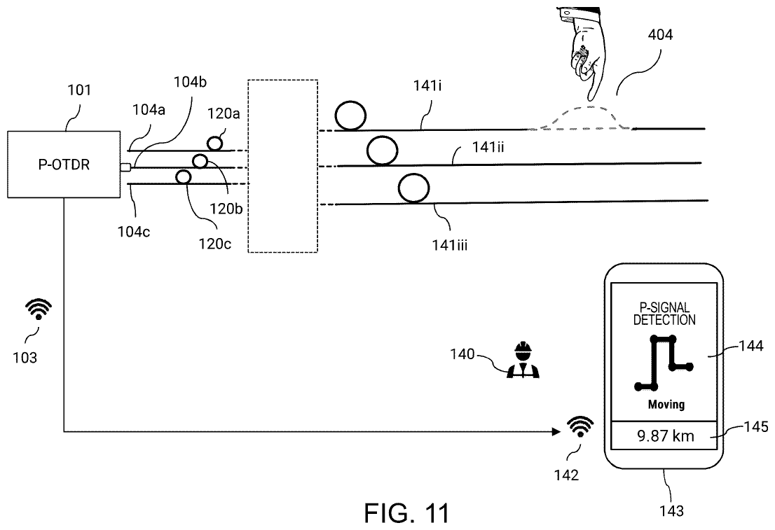

Referring to FIG. 11, in accordance with some implementations, a fiber-identification method is provided. This fiber-identification method may be used with respect to optical system having a plurality of optical fibers 120a, 120b and 120c, each having an optical fiber extremity 104a, 104b or 104c and a distal fiber segment 141i, 141ii or 141iii, and where a “matching” of one of the distal fiber segments with one of the optical fiber extremities is desired. The optical fiber extremities 104 are accessible for connection to a P-OTDR device 101, and the distal fiber segments 141 are accessible to be shaped and moved so as to affect the polarization of light.

The fiber-identification method may generally include the steps of:
a) using a P-OTDR device 101 connected to the fiber extremity of one 104b of the optical fibers defining a test optical fiber 120b, continuously launching polarized light pulses from the P-OTDR device 101 into the fiber extremity 104b of the test optical fiber 120b and obtaining a return light signal from this test optical fiber 120b;
b) isolating a polarization component of the return light signal, and acquiring a set of P-OTDR traces therefrom;
c) concurrently to the launching of the polarization light pulses:
   i. acting on a selected one 141i of the distal fiber segments to vary a polarization state of light travelling in; and
   ii. processing the set of P-OTDR traces to detect a change in polarization of the return light signal; and
d) if a change in polarization of the return signal is not detected, repeating step d) using a different one of said distal fiber segments as the selected distal fiber segment; and
e) upon detecting a change in polarization of the return light signal, reporting an association of the corresponding distal fiber segment with the test optical fiber.

In the illustrated configuration of FIG. 11, the detection of a change in polarization would indicate that distal fiber segment 141i and fiber extremity 104b both belong to a same optical fiber 120b. By way of example, the reporting step may involve a P-OTDR detection status signal 103 being sent by the P-OTDR device 101 and received as a detection status signal 142 by the associated portable device 143, wirelessly, and a detection status indicator 144 being displayed on the portable device 143.

In some implementations, the step of acting on the selected distal fiber segment 141i to vary a polarization state of light travelling therein may involve shaping a portion of the selected distal fiber segment 141i into a curved portion having a curvature larger than a minimum bend radius of the selected distal fiber segment 141, such that the curved portion extends substantially within a plane containing a fiber axis of the selected distal fiber segment 141i, and pivoting the curved portion of the selected distal fiber segment 141 about this fiber axis. The pivoting movement may be carried out manually or using an automated fiber-moving device, as explained above.

In other implementations, the step of acting on the selected distal fiber segment 141i to vary a polarization state of light travelling therein may involve applying other types of mechanical forces on the distal fiber segment. For example, in some embodiments, a pressure could be applied, inducing birefringence in the distal fiber segment. In other embodiments a torsion may be applied to the distal fiber segment, for example using the technique described in U.S. Pat. No. 8,373,852 (RUCHET et al.), the entire contents of which is incorporated herein by reference.

Examples of contexts where the fiber-identification method may be applied include, non-limitatively:
Inter cable splicing: identify the right fiber in a cable without cutting or bending;
Finding & debugging polarity problems in an optical network;
Avoid polarity problems on a site of an optical network;
Identify a Passive Optical Network (PON) client from a cabinet without unplugging or bending any fiber.
Identify an Optical Network Terminal (ONT) without unplugging or bending any fiber; or
Broken fiber identification without unplugging or bending any fiber.

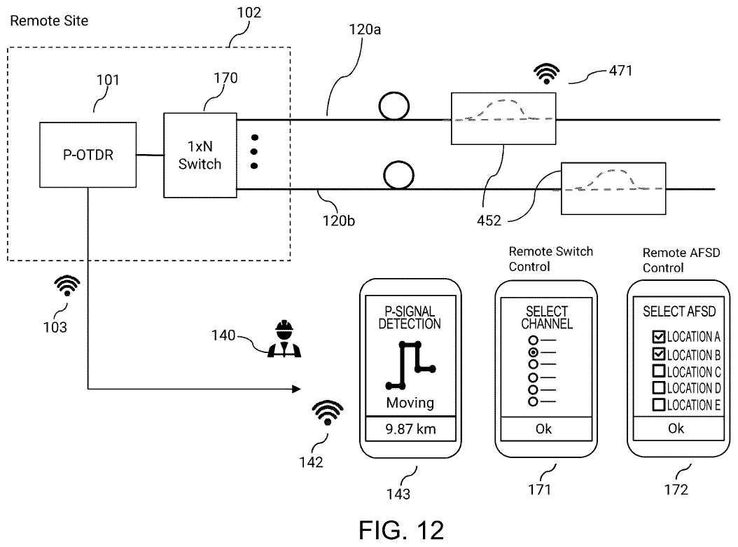

Referring to FIG. 12, there is a shown another example of a fiber-identification method. In this use case, a remote user 140 can identify a plurality of optical fibers or cables by connecting a selection of fibers 120a, 120b to a switch 170 connected to the P-OTDR 101. Automated fiber-moving devices 452 may be connected distal fiber segments of the optical fibers to impart on these fiber segment a pivoting movement affecting light polarization as explained above. Using the switch 170, a user 140 can route the signals from and to the P-OTDR 101 to verify if a specific optical fiber segment is connected to the right path. Control and synchronization of the P-OTDR device 101 and automated fiber moving devices 452 may be operated from a remote switch control 171, which may for example be integrated in a smart phone or other embodiment of a wireless device. By positioning automated fiber-moving devices 452 at key locations on the network, the user can have a clear view of what is connected where and take troubleshooting measures as needed.

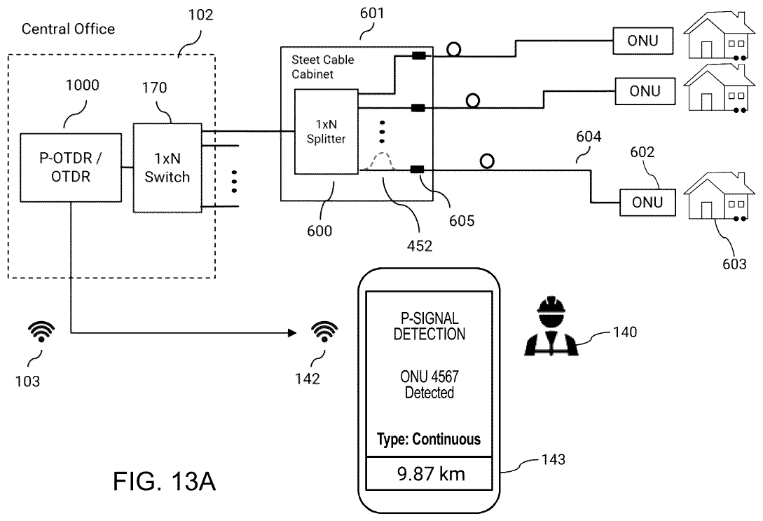

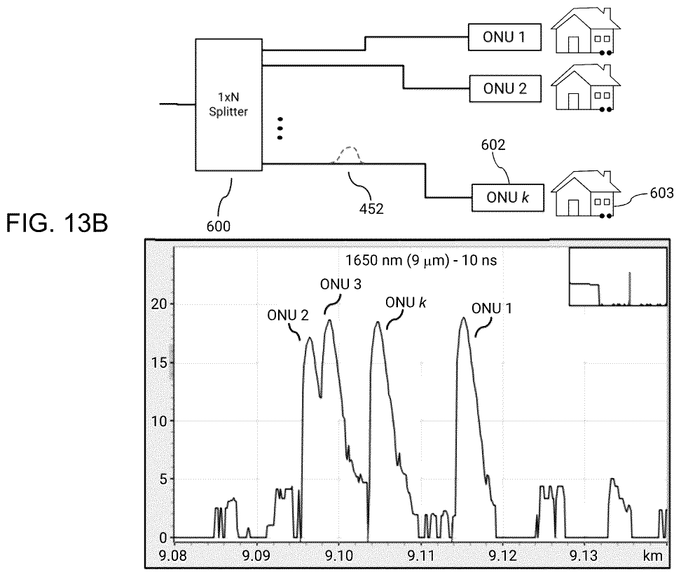

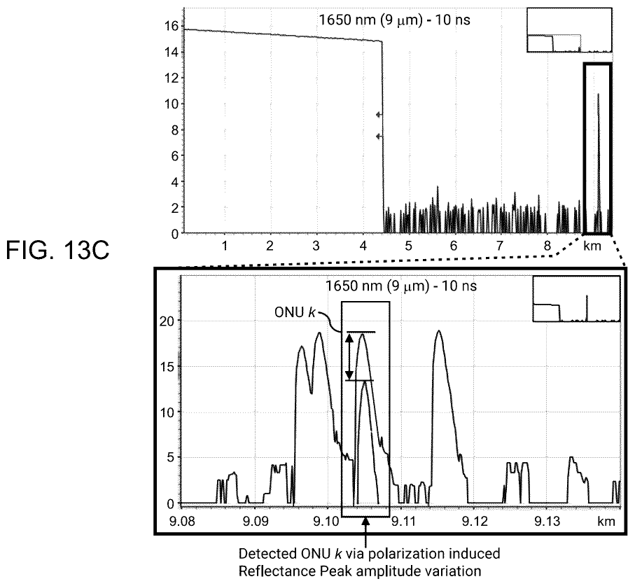

Referring to FIGS. 13A and 13B, there is a shown another example of a fiber-identification method applied to PON (Passive Optical Network) or ONU (Optical Network Unit) Identification.

In this use case, a user 140 can identify one or more target ONUs 602 by providing a switch 170 at the ONT site for example at a Central Office site 102, by connecting a hybrid OTDR/P-OTDR device 1000 to this switch 170 and selecting a street cabinet 601 associated with the ONUs. The street cabinet 601 typically includes a splitter 600 through which each optical fiber is dispatched to a corresponding ONU unit 602 to connect customers 603 to a PON or FTTx network.

In this use case a typical task for a technician 140 is to activate service to customers by connecting to one port 605 of the drop fiber 604 that reaches a given customer's ONU to the right splitter port on the street cabinet 601. Similarly, deactivating service to costumers involves disconnecting the right drop fiber 604. While proper documentation can make such a task simple, technicians are often provided with unclear information, if any, associating customers for drop fibers 604, which can lead to the wrong costumer being connected or disconnected, then impairing the network operation.

Using the method and system shown in FIG. 13A, a technician 140 can activate the P-OTDR device 1000 and move a drop fiber being tested, either manually or using an automated fiber-moving device, to verify, without any risk of impairing the network operation, which optical fiber is connected to the which ONU. In some implementations, these tasks may be performed via a remote-control unit 143. In the PON use case with splitter, only reflectance peaks are typically detected since signal losses after the splitter are usually very strong. In these PON application cases, there is no backscatter, the P-OTDR processing preferably looks for amplitude changes in peaks monitored by a system such as NOVA fiber (see Nova Fiber—RTU-2|Spec sheet|EXFO for FFTx/PON applications). Referring to FIGS. 13B and 13C, when applying a movement 452 to the optical fiber associated to the ONU k, the polarization of the reflective events will change accordingly, which can be detected as an amplitude variation of the reflective event associated to the ONU k by the P-OTDR.

Use cases of the present fiber testing method are not limited to instances of fiber-identification. In other implementations, the fiber testing method may be embodied by a geo-referencing method. Such an embodiment may for example be useful in instances in which a distal fiber segment is known to be associated with an accessible fiber extremity of a given optical fiber, but there is a need to associate its geographical location with the distance travelled by light along the corresponding optical fiber to reach the distal fiber segment.

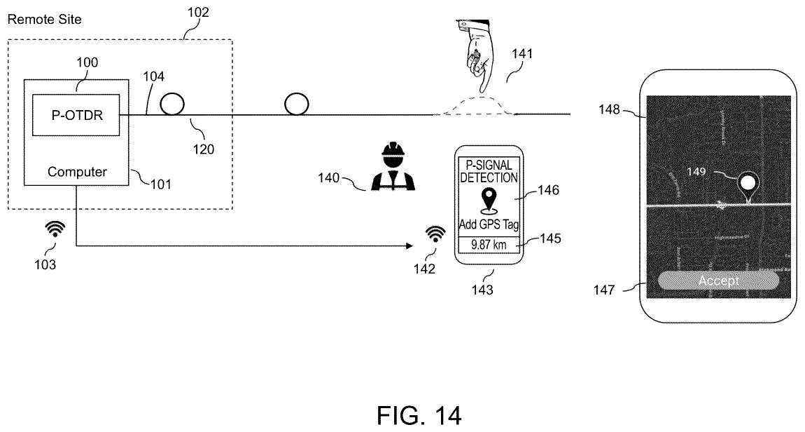

Referring to FIG. 14, in accordance with an embodiment, the geo-referencing method may include the following steps:
a) using a P-OTDR device 100 connected to the fiber extremity 104, continuously launching polarized light pulses from the P-OTDR device 100 into the fiber extremity 104 and obtaining a return light signal from the optical fiber 120;
b) isolating a polarization component of the return light signal, and acquiring a set of P-OTDR traces therefrom;
c) concurrently to the launching of the polarization light pulses:
   i. acting on the distal fiber segment to vary a polarization state of light travelling therein; and
   ii. processing the set of P-OTDR traces to detect a location of a change in polarization of the return light signal;
d) calculating a light-propagation distance 145 between the fiber extremity 104 and the location of a change in polarization of the return light signal; and
e) associating a geographical location 149 of the distal fiber segment 141 with the light-propagation distance 145.

In some implementations, the step of varying a polarization state of light travelling in the distal fiber segment 141 may involve shaping a portion of the distal fiber segment 141 into a curved portion having a curvature larger than a minimum bend radius of the distal fiber segment 141, such that the curved portion extends substantially within a plane containing a fiber axis of the distal fiber segment 141, and pivoting the curved portion of the distal fiber segment 141 about this fiber axis. The pivoting movement may be carried out manually or using an automated fiber-moving device, as explained above.

A smart phone device 143 may be used to display the light-propagation distance 145 and allows the user to add 146 a GPS Tag 149 to a map, the device will add this GPS tag upon user acceptance 147.

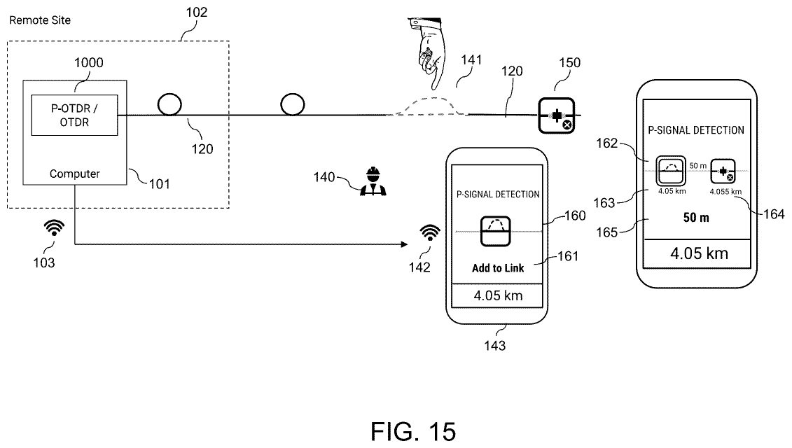

In some implementations, the geo-referencing method above may serve a fault repair assistant function. Referring to FIG. 15, in this use case, the user 140 is tasked with repairing a fault 150 on an optical fiber or cable 120. The OTDR function of a hybrid P-OTDR/OTDR unit 1000 can be used to obtain the optical distance 164 of the fault 150, but the exact physical position, i.e. its geographical location, is not known so the user must find it to do the repair.

The user 141 can access a distal fiber segment 141 of the optical fiber 120. Using the geo-referencing method above, the user 141 can obtain the light-propagation distance associated with this distal segment, by moving the distal fiber segment 141 to affect light polarization, and using the P-OTDR function of the hybrid device 1000 to detects the movement, displays it 160 on the portable device 143, locate the position and propose to add it to the link 161. With the knowledge of the light-propagation distance between the OTDR device 1000 and both the test distal fiber segment 141 and the fault 150 to be repaired, the optical distance between both locations is also known, providing the user with a general idea of the location of the fault from the distal fiber segment just tested. If desired, this process can be repeated with a new test distal fiber segment closer to the fault until the exact position of the fault 165 is located. Optionally, after the repair, the operator can perform an OTDR verification using the OTDR function of the hybrid unit.

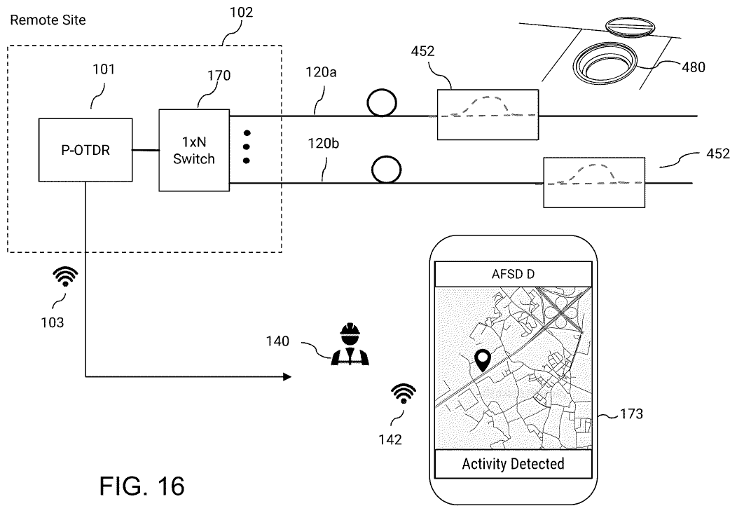

Other use cases of the fiber testing method may be envisioned. For example, referring to FIG. 16, In this use case, a remote operator 140 can monitor the activity at a specific location on an optical network, for example in a manhole 480. As an example, by connecting a selection of optical fibers 120a, 120b to a switch 170 connected to a P-OTDR device 101, using the switch 170 via a remote-control unit 173 the user 140 can route the signal to and from the P-OTDR device 101 to verify the activity at a specific fiber. One or more automated fiber moving devices 452 may be provided on distal fiber segments of the optical fibers 120a and 120b temporarily or permanently, and be commanded to move the distal fiber segments fiber when the manhole 480 is open, generating an activity that can be seen on the control unit 173. In some embodiments, by installing automated fiber-moving devices at key locations on the optical network, the operator 140 may have a clear view of activities at these locations.

Of course, numerous additional modifications could be made to the embodiments described above without departing from the scope of protection as defined in the appended claims.

1. A testing method for an optical fiber system comprising a fiber extremity and a distal fiber segment, the method comprising:
a) using a P-OTDR device connected to the fiber extremity, continuously launching polarized light pulses from the P-OTDR device into the fiber extremity and obtaining a return light signal from said fiber extremity;
b) concurrently to the launching of the polarization light pulses:
i. acting on the distal fiber segment to vary a polarization state of light travelling therein; and
ii. isolating a polarization component of the return light signal, and acquiring a set of P-OTDR traces therefrom;
c) processing the set of P-OTDR traces to detect a change in polarization of the return light signal; and
d) upon detecting said change in polarization of the return light signal, reporting an information relative to the distal fiber segment and the fiber extremity.

2. The testing method according to claim 1, wherein acting on the distal fiber segment comprises:
shaping a portion of the distal fiber segment into a curved portion having a curvature larger than a minimum bend radius of the distal fiber segment, the curved portion extending substantially within a plane containing a fiber axis of the distal fiber segment; and
pivoting the curved portion of the distal fiber segment about said fiber axis.

3. The testing method according to claim 2, wherein the pivoting of the curved portion of the distal fiber segment extends over a maximum range of about 180 degrees.

4. The testing method according to claim 2, wherein the pivoting of the curved portion of the distal fiber segment is performed back and forth.

5. The testing method according to claim 2, comprising providing an automated fiber-moving device, the automated fiber-moving device comprising:
a curved fiber-receiving container, the shaping of a portion of the distal fiber segment into a curved portion comprising inserting the portion of the distal fiber segment into the curved fiber-receiving container; and
a motorized mechanism configured to pivot the curved fiber-receiving cavity about a pivot axis, thereby pivoting the curved portion of the distal fiber segment.

6. The testing method according to claim 1, wherein processing the set of P-OTDR traces comprises:
selecting a block of N consecutive ones of said P-OTDR traces, each P-OTDR trace comprising intensity values of the polarization component of the return light signal as a function of distance indices;
for each distance index, computing a variation indicator based on the intensity values associated with said distance index in the P-OTDR traces within said block;
building a detection trace representative of said variation indicator as a function of distance indices; and
identifying a transition in the detection trace at a transition distance index for which the variation indicator is above a transition threshold.

7. The testing method according to claim 6, wherein the computing of a variation indicator comprises at least one of:
computing a difference between a maximum and a minimum of the intensity values associated with said distance index;
computing a standard deviation of the intensity values associated with said distance index;
computing a Fourier transform of the intensity values associated with said distance index; and
computing a median absolute deviation of the intensity values associated with said distance index.

8. The testing method according to claim 1, wherein said information comprises an indication that the distal fiber segment and the fiber extremity belong to a same optical fiber.

9. The testing method according to claim 1, wherein said information comprises a light-propagation distance between the fiber extremity and the distal fiber segment along a corresponding optical fiber.

10. A fiber-identification method for an optical system having a plurality of optical fibers each having a fiber extremity and a distal fiber segment, the method comprising the steps of:
a) using a P-OTDR device connected to the fiber extremity of one of said optical fibers defining a test optical fiber, continuously launching polarized light pulses from the P-OTDR device into the fiber extremity of the test optical fiber and obtaining a return light signal from said test optical fiber;
b) isolating a polarization component of the return light signal, and acquiring a set of P-OTDR traces therefrom;
c) concurrently to the launching of the polarization light pulses:
i. acting on a selected one of the distal fiber segments to vary a polarization state of light travelling therein; and
ii. processing the set of P-OTDR traces to detect a change in polarization of the return light signal;
d) if a change in polarization of the return signal is not detected, repeating step d) using a different one of said distal fiber segments as the selected distal fiber segment; and
e) upon detecting a change in polarization of the return light signal, reporting an association of the corresponding distal fiber segment with the test optical fiber.

11. The fiber-identification method according to claim 10, wherein acting on a selected one of the distal fiber segments comprises:
shaping a portion of the selected distal fiber segment into a curved portion having a curvature larger than a minimum bend radius of the selected distal fiber segment, the curved portion extending substantially within a plane containing a fiber axis of the selected distal fiber segment; and
pivoting the curved portion of the selected distal fiber segment about said fiber axis.

12. A geo-referencing method for an optical fiber having an accessible fiber extremity and a distal fiber segment, the method comprising:
a) using a P-OTDR device connected to the fiber extremity, continuously launching polarized light pulses from the P-OTDR device into the fiber extremity and obtaining a return light signal from said optical fiber;
b) isolating a polarization component of the return light signal, and acquiring a set of P-OTDR traces therefrom;
c) concurrently to the launching of the polarization light pulses:
i. acting on the distal fiber segment to vary a polarization state of light travelling therein; and
ii. processing the set of P-OTDR traces to detect a location of a change in polarization of the return light signal;
d) calculating a light-propagation distance between the fiber extremity and the location of a change in polarization of the return light signal; and
e) associating a geographical location of the distal fiber segment with said light-propagation distance.

13. The geo-referencing method according to claim 12, wherein acting on the distal fiber segment comprises:
shaping a portion of the distal fiber segment into a curved portion having a curvature larger than a minimum bend radius of the distal fiber segment, the curved portion extending substantially within a plane containing a fiber axis of the distal fiber segment; and
pivoting the curved portion of the distal fiber segment about said fiber axis.

14. A P-OTDR device for testing an optical fiber system comprising a fiber extremity and a distal fiber segment, a polarization state of light travelling in the distal fiber segment being varied, the P-OTDR device comprising:
a polarized light source for generating polarized light pulses;
a connector connectable to the fiber extremity for launching the polarized light pulses from the polarized light source into the fiber extremity and receive a return light signal therefrom;
a polarizing module for isolating a polarization component of the return light signal;
an acquisition optical circuit for acquiring a set of P-OTDR traces from the polarization component of the return light signal;
an OTDR acquisition controller operable to synchronously launch the polarized light pulses from the polarized light source into the optical fiber extremity and acquire the set of P-OTDR traces; and
a signal processor for processing the OTDR trace to detect a change in polarization of the return light signal and, upon detecting said change in polarization of the return light signal, report an information relative to the distal fiber segment and the fiber extremity.

15. The P-OTDR device according to claim 14, wherein the polarizing module comprises a polarizer.

16. The P-OTDR device according to claim 14, wherein the polarizing module is positioned in a path of the return signal between the connector and the acquisition optical circuit.

17. The P-OTDR device according to claim 14, wherein the polarizing module is disposed downstream the connector along an optical fiber associated with the fiber extremity.

18. The P-OTDR device according to claim 14, configured to operate in a P-OTDR mode and in a standard OTDR mode.

19. The P-OTDR device according to claim 14, in combination with an automated fiber-moving device for acting on the distal fiber segment to vary the polarization state of light travelling therein.

20. The combination according to claim 19, wherein the automated fiber-moving device comprises:
a curved fiber-receiving cavity, the curved portion of the distal fiber segment being inserted therein; and
a motorized mechanism configured to pivot the curved fiber-receiving cavity about a pivot axis, thereby pivoting the curved portion of the distal fiber segment.
